(19) United States
(12) Patent Application Publication
(10) Pub. No.: US 2026/0087476 A1
(43) Pub. Date: Mar. 26, 2026

(54) Devices and Methods Utilizing Machine Learning for Item Identification

(71) Applicant: ZEBRA TECHNOLOGIES CORPORATION, Lincolnshire, IL (US)

(72) Inventors: Justin F. Barish, Kings Park, NY (US); Jack Kraszewski, Centerreach, NY (US); Matthew V. Avallone, Dix Hills, NY (US)

(21) Appl. No.: 18/896,801

(22) Filed: Sep. 25, 2024

(51) Int. Cl. G06Q 20/20; G06F 16/55

(52) U.S. Cl. CPC G06Q 20/208; G06F 16/55

(57) ABSTRACT

Methods and devices utilizing machine learning for item identification are disclosed herein. The method captures an image of an item present in a region. The method classifies, based on the image, the item utilizing a machine learning model, and generates, utilizing the machine learning model, one or more candidate items and a score for each candidate item based on the classified item. The method determines whether a score of a candidate item among the one or more candidate items exceeds a threshold. If a score of a candidate item among the one or more candidate items does not exceed the threshold, the method retrieves data associated with each candidate item. The method modifies a score of each candidate item based on the retrieved data and selects a candidate item having a highest modified score. The method updates the database based on the selected candidate item and displays the selected candidate item.

### BACKGROUND

A facility (e.g., a grocery store, convenience store, big box store, or the like) may deploy several point of sale (POS) terminals (e.g., checkout and/or self-checkout terminals) to expedite and improve an experience of a user (e.g., a customer or associate). A POS terminal may include a scanner (e.g., a barcode scanner) to scan an identifier (e.g., a barcode) affixed to an item and identify the item to effect a transaction (e.g., a checkout or self-checkout process) for the item. However, conventional checkout and self-checkout POS terminals do not reliably and efficiently account for exceptions during a checkout or self-checkout process including, but not limited to, an item having an occluded or damaged identifier and an item missing an identifier. For example, some items (e.g., produce including fruits and vegetables, baked goods, or the like) do not include an identifier. These exceptions delay the checkout or self-checkout process and frustrate the experience of a user because conventional checkout and self-checkout POS terminal systems and methods utilize static and/or manual processes to identify an item that does not include an identifier. For example, to identify an item that does not include an identifier, a user may rely on a text-based query to display one or more candidate items from which the user may select. This text-based query process may impede effecting a transaction for an item that does not include an identifier.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram illustrating an embodiment of the present disclosure.

FIG. 2 is a diagram illustrating components of the device and monitor of FIG. 1.

FIG. 3 is a flowchart illustrating processing steps carried out by an embodiment of the present disclosure.

FIG. 4 is an image illustrating step 304 of FIG. 3.

FIG. 5 is a diagram illustrating step 306 of FIG. 3.

FIG. 6 is a diagram illustrating step 310 of FIG. 3.

FIG. 7 is another image illustrating step 304 of FIG. 3.

FIG. 8 is another diagram illustrating step 310 of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As mentioned above, conventional checkout and self-checkout POS terminals do not reliably and efficiently account for exceptions during a checkout or self-checkout process including, but not limited to, an item having an occluded or damaged identifier (e.g., a barcode) and an item missing an identifier. For example, some items (e.g., produce including fruits and vegetables, baked goods, or the like) do not include an identifier. These exceptions delay the checkout or self-checkout process and frustrate the experience of a user (e.g., a customer or associate) because conventional checkout and self-checkout POS terminal systems and methods utilize static and/or manual processes to identify an item that does not include an identifier. For example, a user can manually input identifying information (e.g., an attribute, a characteristic, a description, or the like) of an item via a text-based query and manually select a candidate item from one or more displayed candidate items based on the text-based query. This text-based query process may impede effecting a transaction for an item that does not include an identifier. For example, the text-based query process is manual (e.g., relies on human intervention) and, as such, can be time-consuming, subject to human error, cause undue delay, and thereby frustrate the experience of a user.

The text-based query process also provides for latency via the consumption of substantial amounts of power and processing resources to process a text-based query and display numerous pages of candidate items (some of which may be irrelevant) corresponding to the text-based query. For example, a text-based query may depend on multiple queries to a database storing item data (e.g., an attribute, a characteristic, a description, or the like) which consumes substantial amounts of power and processing resources. In another example, the display of numerous pages of candidate items corresponding to the text-based query also consumes substantial amounts of power and processing resources and is inefficient and time-consuming because a user may scroll through several pages of irrelevant candidate items. Additionally, the text-based process does not automatically and dynamically validate a candidate item from one or more candidate items based on real-time imaging of the item and data associated with one or more candidate items to reduce latency, conserve power and processing resources, and improve the identification and selection of an item by a user to mitigate, if not eliminate, inefficiencies and errors.

As such, conventional systems and methods suffer from a general lack of versatility because these systems cannot automatically and dynamically identify an item that does not include an identifier. For example, these systems and methods cannot automatically and dynamically validate a candidate item from one or more candidate items based on real-time imaging of the item and data associated with one or more candidate items to improve the identification and selection of an item by a user. Overall, this lack of versatility causes conventional systems and methods to provide underwhelming performance and reduce the accuracy, efficiency, and general timeliness of identifying an item (e.g., to effect a transaction such as a checkout or self-checkout process for the item).

Thus, it is an objective of the present disclosure to eliminate these and other problems with conventional systems and methods via systems and methods that can automatically and dynamically identify an item that does not include an identifier by automatically and dynamically validating a candidate item from one or more candidate items based on real-time imaging of the item and data associated with one or more candidate items.

In accordance with the above, and with the disclosure herein, the present disclosure includes improvements in computer functionality or in improvements to other technologies at least because the present disclosure describes that an imaging and/or image processing device (e.g., a scanner of a point of sale (POS) terminal), and related various components, may be improved or enhanced with the disclosed dynamic system features and methods that automatically and dynamically validate a candidate item from one or more candidate items to provide more accurate and efficient processing for the identification of an item.

That is, the present disclosure describes improvements in the functioning of an imaging and/or image processing device and/or system itself or “any other technology or technical field” (e.g., the field of image processing). For example, the disclosed dynamic system features and methods improve and enhance the identification of item that does not include an identifier by automatically and dynamically validating a candidate item from one or more candidate items based on real-time imaging of the item and data associated with the one or more candidate items to mitigate (if not eliminate) user error and eliminate inaccuracies and inefficiencies typically experienced over time by systems lacking such features and methods. This improves the state of the art at least because such previous systems are inaccurate and inefficient as they lack the ability to automatically and dynamically identify an item that does not include an identifier by automatically and dynamically validating a candidate item from one or more candidate items based on real-time imaging of the item and data associated with the one or more candidate items.

In addition, the present disclosure applies various features and functionality, as described herein, with, or by use of, a particular machine, e.g., a processor, a computing device, a POS terminal having a scanner (e.g., a barcode scanner) and/or imaging assembly, a mobile device (e.g., a phone, a tablet, a mobile computer, a sensor, a wearable, or a camera) having a scanner and/or imaging assembly, and/or other hardware components as described herein. Moreover, the present disclosure includes specific features other than what is well-understood, routine, conventional activity in the field, or adding unconventional steps that demonstrate, in various embodiments, particular useful applications, e.g., processing protocols of a scanner (e.g., a barcode scanner) in connection with real-time imaging of an item and data associated with one or more candidate items.

Accordingly, it would be highly beneficial to develop a system and method that can automatically and dynamically identify an item that does not include an identifier by automatically and dynamically validating a candidate item from one or more candidate items based on real-time imaging of the item and data associated with the one or more candidate items. The systems and methods of the present disclosure address these and other needs.

In an embodiment, the present disclosure is directed to a method. The method comprises: capturing, via an imager of a device, an image of an item present within a region where the imager has a field of view (FOV) extending at least partially over the region; classifying, based on the image, the item utilizing a machine learning model; generating, utilizing the machine learning model, one or more candidate items and a score for each candidate item based on the classified item; determining whether a score of a candidate item among the one or more candidate items exceeds a threshold; responsive to determining the score of a candidate item among the one or more candidate items does not exceed the threshold, retrieving, from a database, data associated with each candidate item; modifying a score of each candidate item based on the retrieved data associated with each candidate item; selecting a candidate item having a highest modified score; updating the database based on the selected candidate item having the highest modified score; and displaying the selected candidate item having the highest modified score.

In an embodiment, the present disclosure is directed to a device comprising an imager having a field of view (FOV) extending at least partially over a region; one or more memories; and one or more processors, communicatively coupled to the one or more memories. The one or more processors are configured to: capture, via the imager, an image of an item present within the region; classify, based on the image, the item utilizing a machine learning model; generate, utilizing the machine learning model, one or more candidate items and a score for each candidate item based on the classified item; determine whether a score of a candidate item among the one or more candidate items exceeds a threshold; responsive to determining the score of a candidate item among the one or more candidate items does not exceed the threshold, retrieve, from a database, data associated with each candidate item; modify a score of each candidate item based on the retrieved data associated with each candidate item; select a candidate item having a highest modified score; update the database based on the selected candidate item having the highest modified score; and display the selected candidate item having the highest modified score.

In an embodiment, the present disclosure is directed to a non-transitory computer-readable medium. The non-transitory computer-readable medium stores instructions thereon that, when executed by one or more processors, cause the one or more processors to: capture, via an imager of a device, an image of an item present within a region, the imager having a field of view (FOV) extending at least partially over the region; classify, based on the image, the item utilizing a machine learning model; generate, utilizing the machine learning model, one or more candidate items and a score for each candidate item based on the classified item; determine whether a score of a candidate item among the one or more candidate items exceeds a threshold; responsive to determining the score of a candidate item among the one or more candidate items does not exceed the threshold, retrieve, from a database, data associated with each candidate item; modify a score of each candidate item based on the retrieved data associated with each candidate item; select a candidate item having a highest modified score; update the database based on the selected candidate item having the highest modified score; and display the selected candidate item having the highest modified score.

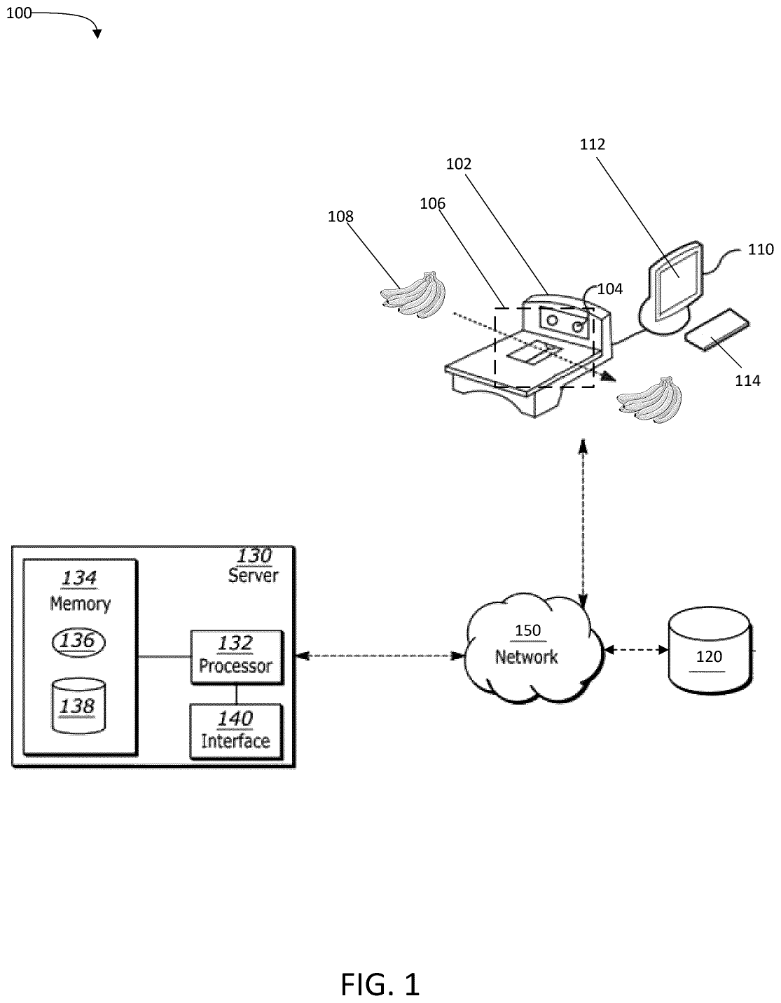

Turning to the Drawings, FIG. 1 is a diagram 100 illustrating an embodiment of the present disclosure. FIG. 1 illustrates a system for identifying an item. The system can be deployed in a facility (e.g., a grocery store, convenience store, big box store, etc.). As shown in FIG. 1, the system can include a device 102 (e.g., a scanner, a smart phone, a tablet computer, a mobile computer, a wearable or the like), a monitor 110, a database 120, and a server 130. The device 102, the monitor 110, the database 120, and the server 130 can exchange data via a network 150 implemented as any suitable local area network or local wide-area network or combination thereof.

The device 102 can be operated by a user (e.g., a customer or an associate) at the facility, and includes an imaging assembly 104 (e.g., a camera or an imager) having a field of view (FOV) extending at least partially over a region 106 and/or a sensor (e.g., a proximity sensor, a load cell such as a scale, or the like). The device 102 can capture, via the imaging assembly 104, an image of an item 108 present in the region 106. The device 102 can be manipulated to capture an image or a stream of images of the object 106. From an image or a stream of images, the device 102 can automatically and dynamically identify an item 108 that does not include an identifier. For example, the device 102 can classify, based on an image, an item 108 utilizing a machine learning model; generate, utilizing the machine learning model, one or more candidate items and a score for each candidate item based on the classified item 108; determine whether a score of a candidate item among the one or more candidate items exceeds a threshold; responsive to determining the score of a candidate item among the one or more candidate items does not exceed the threshold, retrieve, from a database 120, data associated with each candidate item; modify a score of each candidate item based on the retrieved data associated with each candidate item; select a candidate item having a highest modified score; update the database 120 based on the selected candidate item having the highest modified score; and display the selected candidate item having the highest modified score. Alternatively, responsive to determining the score of a candidate item among the one or more candidate items exceeds the threshold, the device 102 can select the candidate item having the score that exceeds the threshold, and display the selected candidate item having the score that exceeds the threshold.

The device 102 may be coupled to a monitor 110 having a display 112 and an input device 114. The display 112 may be a touchscreen. The input device 114 can include any one of, or a suitable combination of, a touch screen integrated with the display 112, a keyboard, a keypad, a mouse, a microphone, and the like. The monitor 110 may display a selected candidate item and/or receive an input (e.g., to confirm a candidate item) from a user via the display 112 or the input device 114. For example, a user can utilize a touchscreen, keyboard, keypad, mouse, and/or microphone to confirm a candidate item corresponds to an item 108 that does not include an identifier. It should be understood that the monitor 110, including the display 112, and the input device 114 may be external to the device 102, may be integrated with the device 102, or may be integrated with the device 102 within a housing (e.g., a kiosk, POS terminal, or the like).

The database 120 stores data associated with a plurality of items within and/or associated with a facility including one or more candidate items. The data can include, but is not limited to, historical transaction data of a user associated with a candidate item; association data indicative of one or more other items associated with a candidate item; and time series data indicative of a seasonality associated with a candidate item. It should be understood that the database 120 may be external to the device 102 or may be a component of the device 102 and/or the server 130.

Regarding the historical transaction data, the system may receive an identifier of a user thereby providing historical transaction data of the user indicative of item preferences (e.g., frequently purchased items). In this way, the system can determine a likelihood that a candidate item corresponds to a captured image of an item 108 that does not include an identifier. For example, if the system determines, based on the historical transaction data, that a user infrequently purchases a candidate item, then the system is likely to conclude that the candidate item does not correspond to the captured image of the item 108 that does not include an identifier.

Regarding the association data, the system may utilize one or more previously scanned and/or identified items to determine a likelihood that a candidate item corresponds to a captured image of an item 108 that does not include an identifier based on whether the candidate item is generally associated with the one or more previously scanned and/or identified items. For example, if the system scans pudding mix, milk, and vanilla wafers, subsequently captures an image of a banana that does not include an identifier, and provides a banana and a plantain as candidate items, the system is likely to conclude that the banana candidate item corresponds to the captured image of the banana because a banana is generally associated with pudding mix, milk, and vanilla wafers to make banana pudding.

Regarding the time series data, the system can utilize time series data associated with a candidate item to determine a likelihood the candidate item corresponds to a captured image of an item 108 that does not include an identifier. For example, if the system determines, based on the time series data, that a candidate item is not in season, then the system is likely to conclude that the candidate item does not correspond to the captured image of the item 108 that does not include an identifier. In another example, if the system determines, based on the time series data, that a candidate item is commonly purchased during a current season and/or holiday, then the system is likely to conclude that the candidate item corresponds to the captured image of the item 108 that does not include an identifier.

The server 130 can include a processor 132 (e.g. one or more central processing units (CPUs)), interconnected with a non-transitory computer readable storage medium, such as a memory 134 and an interface 140. The memory 134 includes a combination of volatile memory (e.g. Random Access Memory or RAM) and non-volatile memory (e.g. read only memory or ROM, Electrically Erasable Programmable Read Only Memory or EEPROM, flash memory). The processor 132 and the memory 134 each comprise one or more integrated circuits.

The memory 134 stores computer readable instructions for execution by the processor 132. The memory 134 stores an identification application 136 (also referred to simply as the application 136) which, when executed by the processor 132, configures the processor 132 to perform various functions described below in greater detail and related to automatically and dynamically identifying an item that does not include an identifier by automatically and dynamically validating a candidate item from one or more candidate items based on real-time imaging of the item and data associated with the one or more candidate items. As described below, this functionality can also be executed by the processor 202 of the device 102.

The application 136 may also be implemented as a suite of distinct applications in other examples. Those skilled in the art will appreciate that the functionality implemented by the processor 132 via the execution of the application 136 may also be implemented by one or more specially designed hardware and firmware components, such as field-programmable gate arrays (FPGAs), application-specific integrated circuits (ASICs) and the like in other embodiments. The memory 134 also stores a database 138 including one or more image datasets of a plurality of items (e.g., for training a machine learning model to detect and classify an item). As noted below, the database 138 may be stored in a memory (not shown) of the device 102.

The server 130 also includes a communications interface 140 enabling the server 130 to communicate with other computing devices, including the device 102, via the network 150. The communications interface 140 includes suitable hardware elements (e.g. transceivers, ports and the like) and corresponding firmware according to the communications technology employed by the network 150.

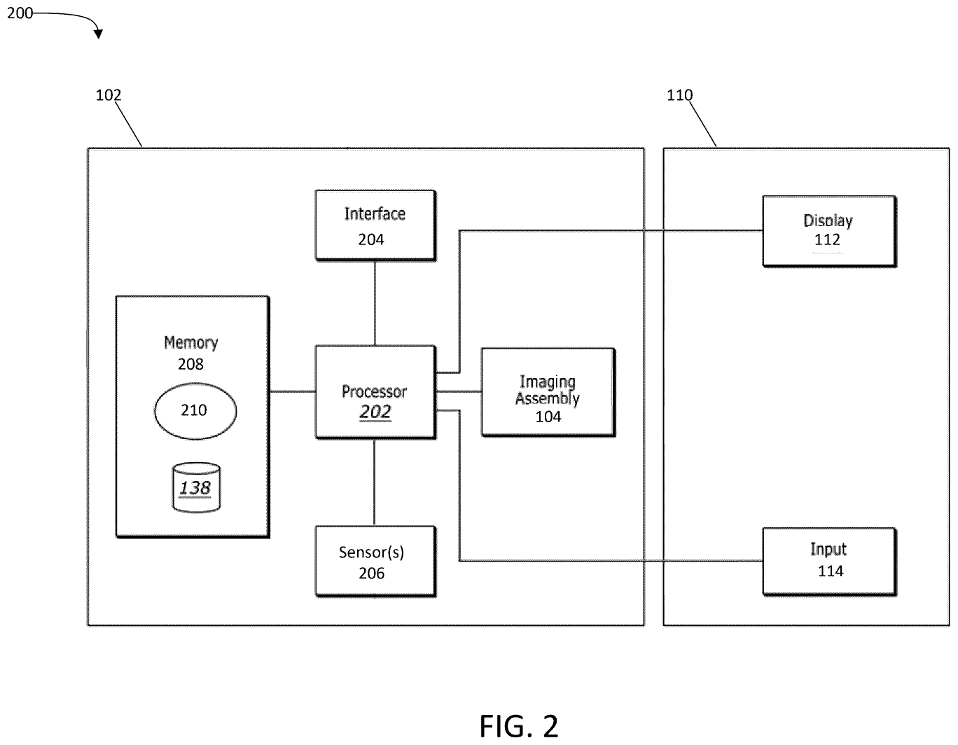

FIG. 2 is a diagram 200 illustrating components of the device 102 and monitor 110 of FIG. 1. The device 102 includes a processor 202 (e.g. one or more CPUs), interconnected with a non-transitory computer readable storage medium, such as a memory 208, an imaging assembly 104, an interface 204, and sensor(s) 206. The memory 208 includes a combination of volatile memory (e.g. Random Access Memory or RAM) and non-volatile memory (e.g. read only memory or ROM, Electrically Erasable Programmable Read Only Memory or EEPROM, flash memory). The processor 202 and the memory 208 each comprise one or more integrated circuits. The monitor 110 includes a display 112 and an input 114 interconnected with the processor 202 of the device 102. As mentioned above, the monitor 110, including the display 112, and input device 114 may be external to the device 102, may be integrated with the device 102, or may be integrated with the device 102 within a housing (e.g., a kiosk, POS terminal, or the like).

The imaging assembly 104 (e.g., a camera or imager) may include a suitable sensor (e.g., a proximity sensor) or combination of sensors. Alternatively, the imaging assembly 104 and the sensor(s) 206 (e.g., a TOF sensor, a proximity sensor, a load cell such as a scale, etc.) may be independent of one another. In another alternative, the device 102 may be an imaging assembly 210 (e.g., a camera or imager) and/or a sensor 206 (e.g., a proximity sensor). For example, the device 102 can be a camera and/or a proximity sensor mounted in a position such that the camera and/or proximity sensor has a FOV including an item 108 and can be manipulated to capture an image or a stream of images of the item 108. From such images, the device 102 can automatically and dynamically identify an item that does not include an identifier by automatically and dynamically validating a candidate item from one or more candidate items based on real-time imaging of the item 108 and data associated with the one or more candidate items.

The memory 208 stores computer readable instructions for execution by the processor 202. In particular, the memory 208 stores an identification application 210 (also referred to simply as the application 210) which, when executed by the processor 202, configures the processor 202 to perform various functions discussed below in greater detail and related to automatically and dynamically identifying an item 108 that does not include an identifier by automatically and dynamically validating a candidate item from one or more candidate items based on real-time imaging of the item 108 and data associated with the one or more candidate items.

The application 210 may also be implemented as a suite of distinct applications in other examples. Those skilled in the art will appreciate that the functionality implemented by the processor 202 via the execution of the application 210 may also be implemented by one or more specially designed hardware and firmware components, such as FPGAs, ASICs and the like in other embodiments. As noted above, in some examples the memory 208 can also store the database 138, rather than the database 138 being stored at the server 130. The database 138 can include one or more image datasets of a plurality of items (e.g., for training a machine learning model to detect and classify an item 108).

The communications interface 204 enables the device 102 to communicate with other computing devices, such as the server 130, via the network 150. The interface 204 therefore includes a suitable combination of hardware elements (e.g. transceivers, antenna elements and the like) and accompanying firmware to enable such communication.

In addition to the display 112, the device 102 can also include one or more other output devices, such as a speaker, a notification light-emitting diode (LED), and the like (not shown). The at least one input 114 can be a device interconnected with the processor 202. The input device 114 is configured to receive an input (e.g. from a user of the device 102) and provide data representative of the received input to the processor 202. The input device 114 can include any one of, or a suitable combination of, a touch screen integrated with the display 112, a keyboard, a keypad, a mouse, a microphone, and the like. For example, a user can utilize the touchscreen, keyboard, keypad, mouse, and/or microphone to confirm a candidate item displayed via the display 112 corresponds to an item 108 that does not include an identifier.

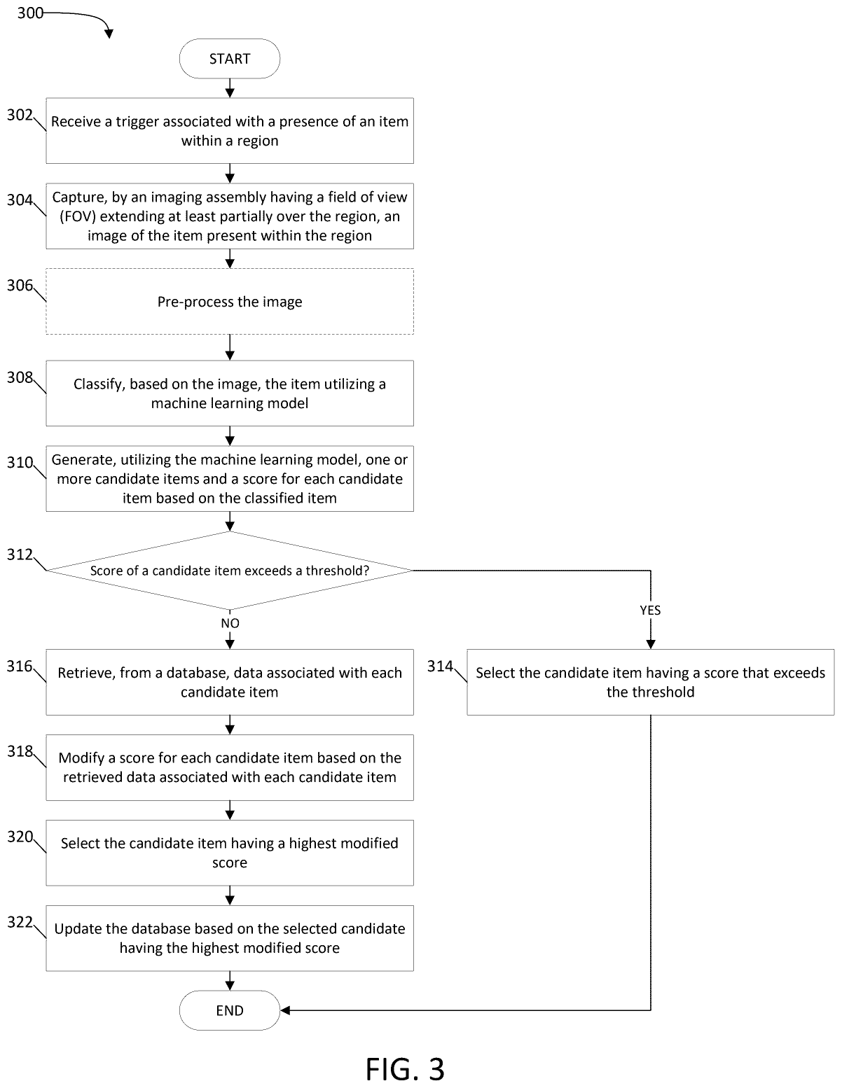

FIG. 3 is a flowchart 300 illustrating processing steps carried out by an embodiment of the present disclosure. The processing steps will be described in conjunction with their performance in the system (e.g., by the device 102, the device 102 and monitor 110, the server 130 in conjunction with the device 102, or the server in conjunction with the device 102 and monitor 110). In general, via performance of the processing steps, the system can automatically and dynamically identify an item that does not include an identifier by automatically and dynamically validating a candidate item from one or more candidate items based on real-time imaging of the item and data associated with the one or more candidate items. For example, the system can capture, via an imager of a device, an image of an item present in a region where the imager has a field of view (FOV) extending at least partially over the region; classify, based on the image, the item utilizing a machine learning model; generate, utilizing the machine learning model, one or more candidate items and a score for each candidate item based on the classified item; determine whether a score of a candidate item among the one or more candidate items exceeds a threshold; responsive to determining the score of a candidate item among the one or more candidate items does not exceed the threshold, retrieve, from a database, data associated with each candidate item; modify a score of each candidate item based on the retrieved data associated with each candidate item; select a candidate item having a highest modified score; update the database based on the selected candidate item having the highest modified score; and display the selected candidate item having the highest modified score.

Referring to FIG. 3, in step 302, the system receives a trigger associated with a presence of an item 108 within the region 106. The trigger can be one or more of detecting, by an imaging assembly 104, an item 108 present within the region 106; receiving an input, via an input device 114, indicative of an item 108 being present within the region 106, or receiving a trigger from a load sensor 206 of the device 102 based on a measurement at the load sensor 206 satisfying a weight threshold. For example, a camera and/or proximity sensor 206 of the imaging assembly 104 may detect an item 108 present within the region 106, a user may submit an input via any one of, or a suitable combination of, a touch screen integrated with the display 112, or an input device including, but not limited to, a keyboard, a keypad, a mouse, and a microphone indicating an item 108 is present within the region 106, or a load cell 206 of the device 102 may transmit a signal when a weight of an item 108 on the load cell 206 satisfies a threshold.

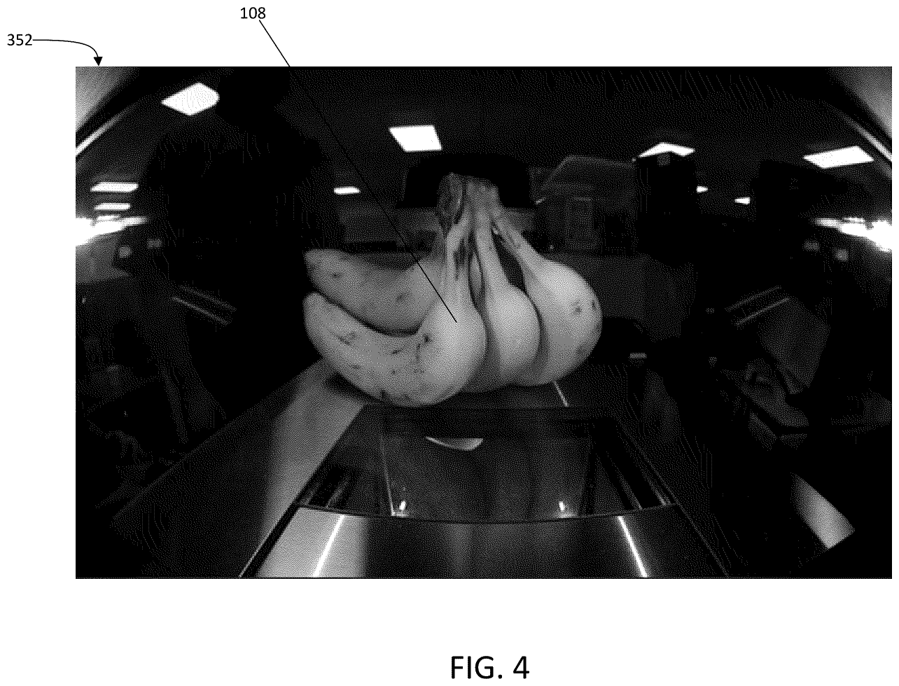

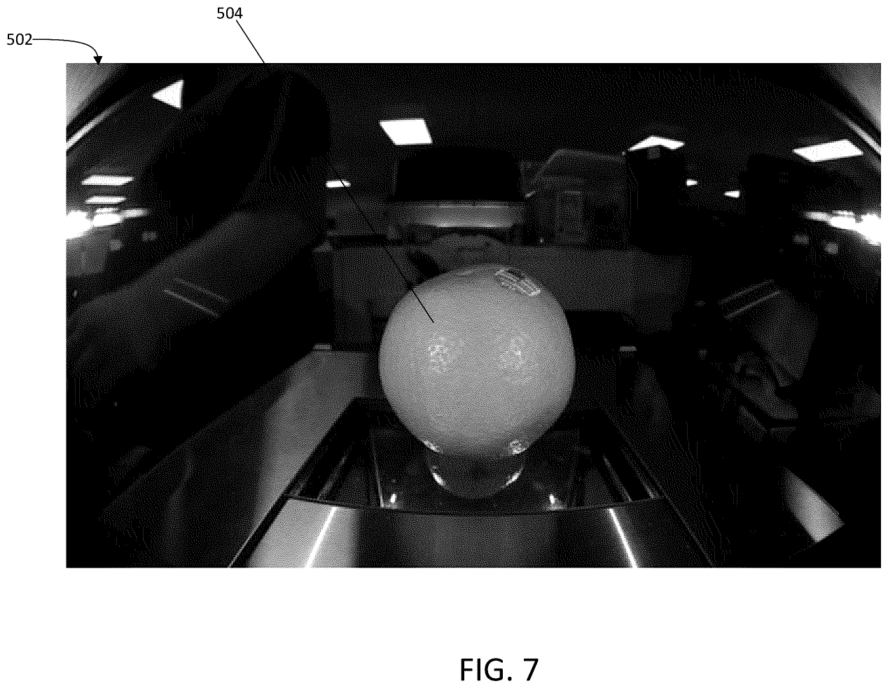

In step 304, the system captures, by the imaging assembly 104, an image of an item 108 present within the region 106. The imaging assembly 104, may have a FOV extending at least partially over the region 106 to capture an image of an item 108 present within the region 106. FIGS. 4 and 7 are images illustrating step 304 of FIG. 3. FIG. 4 is an image 352 of an item 108 (e.g., bananas) captured by the imaging assembly 104 (not shown). FIG. 7 is an image 502 of an item 504 (an orange) captured by the imaging assembly 104.

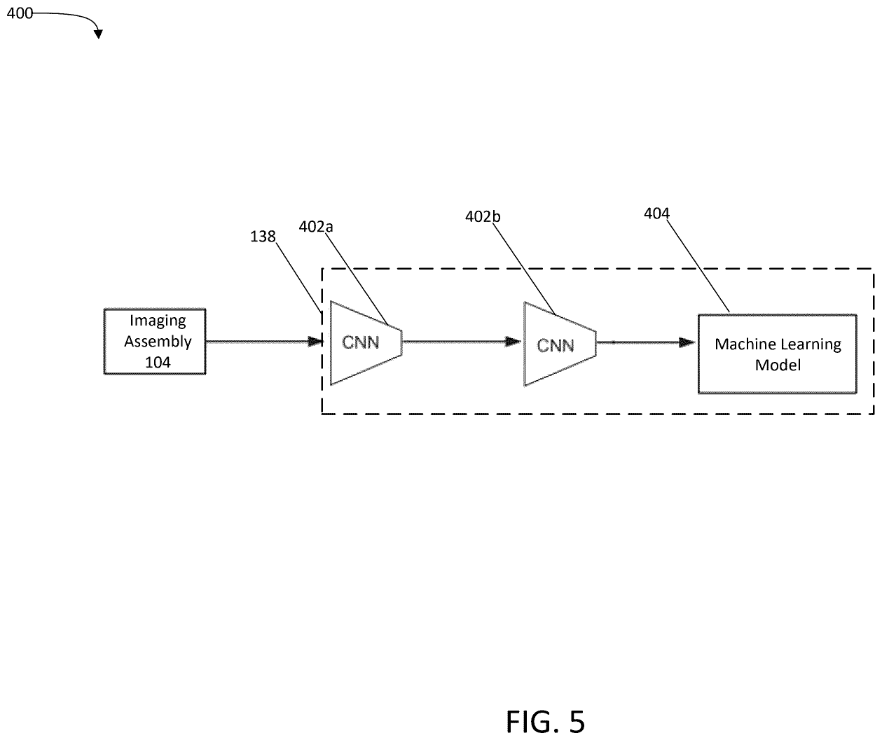

Referring back to FIG. 3, in step 306, the system optionally pre-processes an image of an item 108. FIG. 5 is a diagram 400 illustrating step 306 of FIG. 3 in greater detail. As shown in FIG. 5, the system can apply a first convolutional neural network (CNN) 402a to an image of an item 108 captured by the imaging assembly 104 to determine a bounding box associated with the item 108. The system can determine the item 108 within the bounding box satisfies an occlusion threshold and apply a second CNN 402b to determine a query image. The system can classify, based on the query image, the item 108 utilizing a machine learning model 404. In this way, the system can determine whether an image is suitable for classification by the machine learning model 404. For example, if the system determines an item 108 within a bounding box does not satisfy an occlusion threshold, then the system can capture another image of the item 108. It should be understood that the first CNN 402a, the second CNN 402b, and the machine learning model may be included in a database 138 stored in a memory 134 of a server 130 or a memory 208 of a device 102.

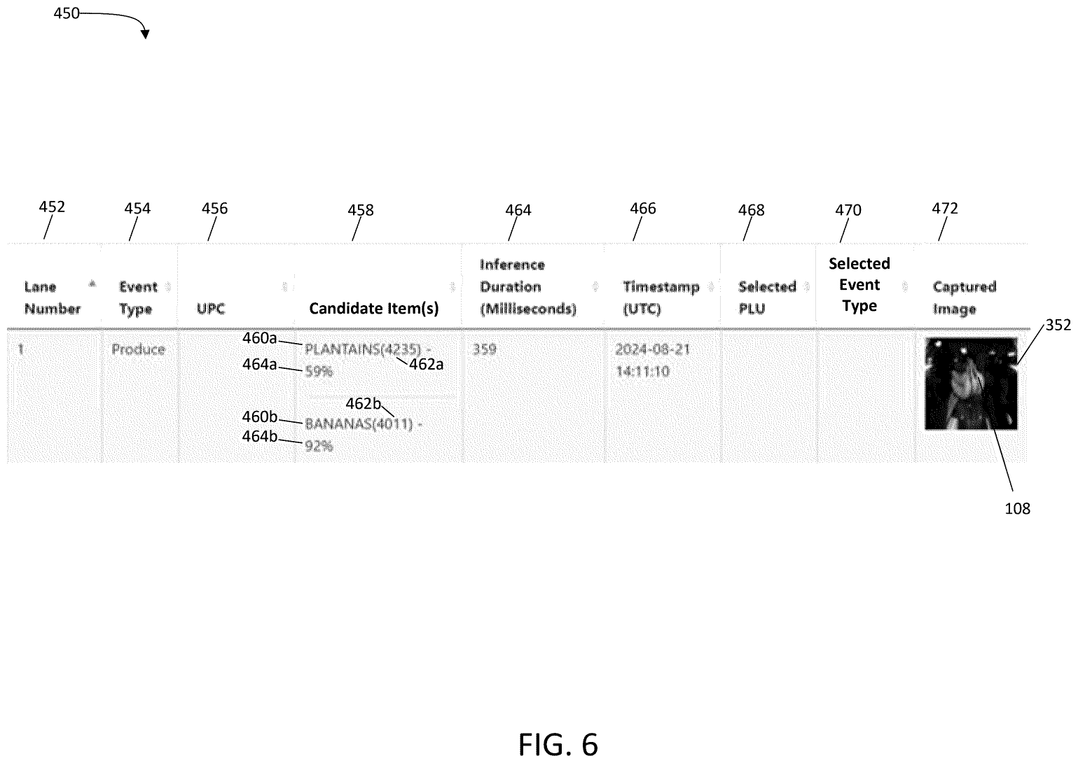

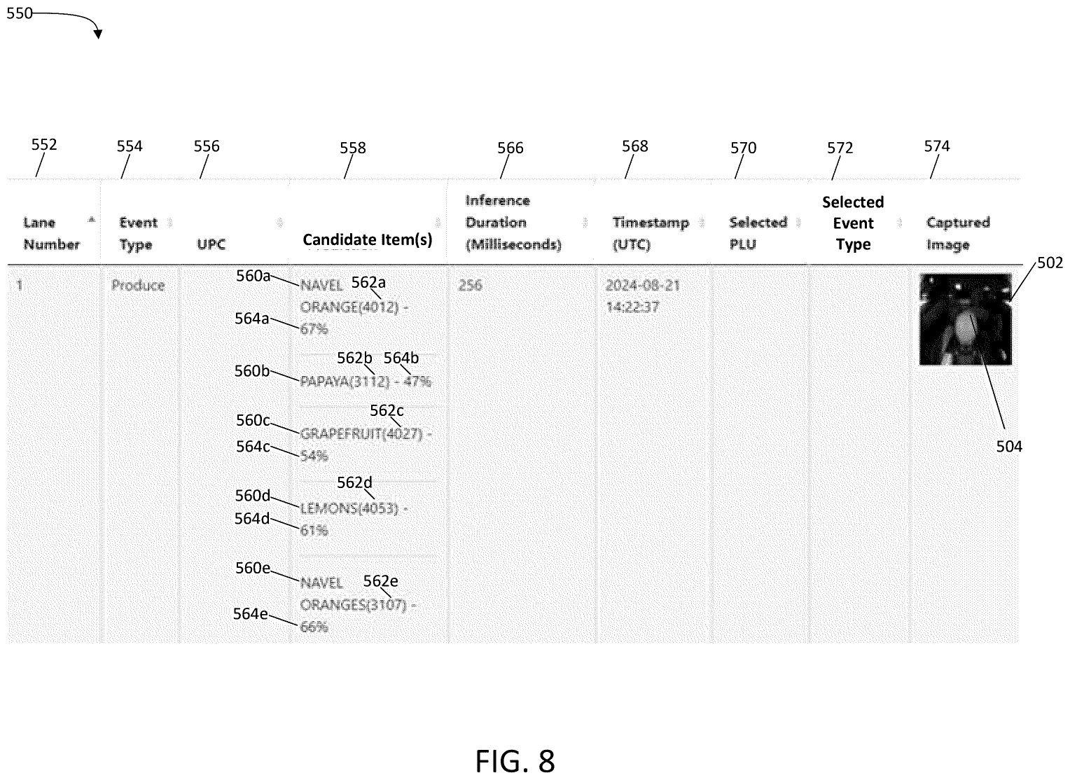

Referring back to FIG. 3, in step 308, the system classifies an item 108 present in a captured image utilizing a machine learning model. In step 310, the system generates, utilizing a machine learning model, one or more candidate items and a score for each candidate item based on a classified item 108. A candidate item is an item that likely corresponds to a classified item 108 and a score is a confidence value indicative of the candidate item corresponding to the classified item 108. FIG. 6 is a diagram 450 illustrating step 310 of FIG. 3 based on image 352 of FIG. 4 and FIG. 8 is a diagram 550 illustrating step 310 of FIG. 3 based on image 502 of FIG. 7.

As shown in FIG. 6, the system may generate a table based on a captured image 352 of an item 108. The table may comprise several fields including, but not limited to, a lane number 452 (e.g., an integer value corresponding to a scanner and/or POS terminal); an event type 454 (e.g., produce, baked goods, or the like); a Universal Product Code (UPC) 456; candidate item(s) 458; an inference duration 464; a time stamp 466; a selected Price Lookup Code (PLU); a selected event type 470; and a captured image 472. As shown in FIG. 6, based on the captured image 352 of an item 108 classified as a banana, the system generates two candidate items 460a and 460b. The candidate item 460a corresponds to “PLANTAINS” having a PLU 462a of “4235” and a score 464a of “59%”. The candidate item 460b corresponds to “BANANAS” having a PLU 462b of “4011” and a score 464b of “92%”. As described in further detail below, based on the scores 464a and 464b and a set threshold (e.g., a minimum confidence value indicative of candidate items 460a and 460b corresponding to the classified item 108), the system may conclude that the candidate item 460b corresponds to the classified item 108. In this way and evidenced by the inference duration of 359 milliseconds, the system can accurately and efficiently identify an item 108 that does not include an identifier by automatically and dynamically validating a candidate item from one or more candidate items based on real-time imaging of the item 108 and data associated with the one or more candidate items.

As shown in FIG. 8, the system may generate a table based on a captured image 502 of an item 504. The table may comprise several fields including, but not limited to, a lane number 552 (e.g., an integer value corresponding to a scanner and/or POS terminal); an event type 554 (e.g., produce, baked goods, or the like); a UPC 556; candidate item(s) 558; an inference duration 566; a time stamp 568; a selected PLU 570; a selected event type 572; and a captured image 574. As shown in FIG. 8, based on the captured image 502 of an item 504 classified as an orange, the system generates five candidate items 560a, 560b, 560c, 560d, and 560e. The candidate item 560a corresponds to a “NAVEL ORANGE” having a PLU 562a of “4012” and a score 564a of “67%”. The candidate item 560b corresponds to a “PAPAYA” having a PLU 562b of “3112” and a score 564b of “47%”. The candidate item 560c corresponds to a “GRAPEFRUIT” having a PLU 562c of “4027” and a score 564c of “54%”. The candidate item 560d corresponds to “LEMONS” having a PLU 562d of “4053” and a score 564d of “61%”. The candidate item 560e corresponds to “NAVEL ORANGES” having a PLU 562e of “3107” and a score 564e of “66%”. As described in further detail below, based on the respective scores 564a-e and a set threshold (e.g., a minimum confidence value indicative of candidate items 560a-e corresponding to the classified item 504 and/or a minimum difference value among respective scores 564a-e of respective candidate items 560a-e), the system may retrieve data associated with each candidate item 560a-e and modify respective scores 564a-e of respective candidate items 560a-e based on the retrieved data to validate a candidate item from the candidate items 560a-e.

Referring back to FIG. 3, in step 312, the system determines whether a score of a candidate item exceeds a threshold. The threshold may be a minimum confidence value indicative of a candidate item corresponding to a classified item. The threshold may also be a minimum difference value among respective scores of respective candidate items. For example, the system may require that a score of a candidate item exceeds a minimum confidence value of 70% and/or that a score of a candidate item exceeds a minimum difference value of 5% among respective scores of respective candidate items. The system or a user may set the threshold, and the threshold may be an integer value or a percentage.

If the system determines a score of a candidate item exceeds a threshold, then the process proceeds to step 314. In step 314, the system selects the candidate item having the score that exceeds the threshold. The system may display, via a display 112 of a monitor 110, the selected candidate item having the score that exceeds the threshold. In response to the display of the selected candidate item, the system may receive an input associated with the selected candidate item, via an input device 114, from a user and cause a transaction, based on the input, to be processed using the selected candidate item. For example, in response to a display of a selected candidate item, a user may confirm the selected candidate item corresponds to an item 108 and thereby cause a transaction (e.g., a purchase) of the item 108 to be processed using the selected candidate item.

Alternatively, if the system determines a score of a candidate item does not exceed a threshold, then the process proceeds to step 316. For example, the system may determine that a score of a candidate item does not exceed a minimum confidence value and/or that a score of a candidate item does not exceed a minimum difference value among each score of each candidate item. In step 316, the system retrieves from a database 120, data associated with each candidate item. The database 120 may be external to the device 102 or may be a component of the device 102 and/or the server 130. The database 120 stores data associated with a plurality of items within and/or associated with a facility including one or more candidate items. The data can include, but is not limited to, historical transaction data of a user associated with a candidate item; association data indicative of one or more other items associated with a candidate item; and time series data indicative of a seasonality associated with a candidate item. For example, if the system determines, based on the historical transaction data, that a user infrequently purchases a candidate item, then the system is likely to conclude that the candidate item does not correspond to the classified item 108. In another example, regarding the association data, if the system scans pudding mix, milk, and vanilla wafers, subsequently captures an image of an item 108 where the item 108 is a banana, and provides a banana and a plantain as candidate items, the system is likely to conclude that the banana candidate item corresponds to the item 108 because a banana is generally associated with pudding mix, milk, and vanilla wafers to make banana pudding. In yet another example, regarding the time series data, if the system determines that a candidate item is not in season, then the system is likely to conclude that the candidate item does not correspond to the classified item 108. In another example, regarding the time series data, if the system determines, based on the time series data, that a candidate item is commonly purchased during a current season and/or holiday, then the system is likely to conclude that the candidate item corresponds to the classified item 108.

In step 318, the system modifies a score of each candidate item based on the retrieved data associated with each candidate item. The system may increase or decrease a score of each candidate item based on one or more weights applied to the retrieved data. For example, if the system: (1) determines, based on the historical transaction data, that a candidate item is 95% likely to be purchased by a user, then the system may apply a weight of 0.3× to the historical transaction data; (2) determines, based on the association data, that the candidate item is 80% likely to be associated with one or more scanned items, then the system may apply a weight of 0.1× to the association data; and (3) determines, based on the time series data, that the candidate item is 90% likely to be purchased during a current season and/or holiday, then the system may apply a weight of 0.6× to the time series data. A weight may be set by the system or a user based on an importance and/or relevance of the retrieved data. The system may then modify an initial score of 65% of the candidate item by applying the weights to the retrieved data (e.g., (0.3*0.95)+(0.1*0.80)+(0.6*0.90)=0.91) of the candidate item to yield a modified score of 59% (e.g., 0.91*0.65=0.59). Thus, the system may decrease a score of the candidate item based on one or more weights applied to the retrieved data of the candidate item.

In step 320, the system selects a candidate item having a highest modified score. Then, in step 322, the system updates the database 120 based on the selected candidate having the highest modified score. The system may display, via a display 112 of a monitor 110, the selected candidate item having the highest modified score. In response to the display of the selected candidate item having the highest modified score, the system may receive an input associated with the selected candidate item, via an input device 114, from a user and cause a transaction, based on the input, to be processed using the selected candidate item. For example, in response to a display of a selected candidate item having the highest modified score, a user may confirm the selected candidate item corresponds to an item 108 and thereby cause a transaction (e.g., a purchase) of the item 108 to be processed using the selected candidate item having the highest modified score.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed:

1. A method, comprising:
capturing, via an imager of a device, an image of an item present within a region, the imager having a field of view (FOV) extending at least partially over the region;
classifying, based on the image, the item utilizing a machine learning model;
generating, utilizing the machine learning model, one or more candidate items and a score for each candidate item based on the classified item;
determining whether a score of a candidate item among the one or more candidate items exceeds a threshold;
responsive to determining the score of a candidate item among the one or more candidate items does not exceed the threshold, retrieving, from a database, data associated with each candidate item;
modifying a score of each candidate item based on the retrieved data associated with each candidate item;
selecting a candidate item having a highest modified score;
updating the database based on the selected candidate item having the highest modified score; and
displaying the selected candidate item having the highest modified score.

2. The method of claim 1, further comprising receiving, at a controller, a trigger associated with the item being present within the region, wherein receiving the trigger comprises one or more of:
detecting, by the imager, the item being present within the region;
receiving an input indicative of the item being present within the region; or
receiving a trigger from a load sensor of the device based on a measurement at the load sensor satisfying a weight threshold.

3. The method of claim 1, further comprising:
applying a first convolutional neural network (CNN) to the image to determine a bounding box associated with the item;
determining the item within the bounding box satisfies an occlusion threshold;
applying a second CNN to the image to determine a query image; and
classifying, based on the query image, the item utilizing the machine learning model.

4. The method of claim 1, wherein
the device is a scanner; and
the threshold is one or more of:
a minimum confidence value indicative of a candidate item corresponding to the classified item; or
a minimum difference value among each score of each candidate item.

5. The method of claim 1, further comprising:
responsive to determining the score of a candidate item among the one or more candidate items exceeds the threshold, selecting the candidate item having the score that exceeds the threshold;
displaying the selected candidate item having the score that exceeds the threshold.

6. The method of claim 1, wherein the retrieved data associated with each candidate item is one or more of:
historical transaction data of a user associated with the candidate item;
association data indicative of one or more other items associated with the candidate item; or
time series data indicative of a seasonality associated with the candidate item.

7. The method of claim 1, wherein modifying the score of each candidate item based on the retrieved data associated with each candidate item comprises increasing or decreasing the score of each candidate item based on one or more weights applied to the retrieved data.

8. The method of claim 1, further comprising:
receiving an input associated with the selected candidate item; and
causing, based on the input, a transaction to be processed using the selected candidate item.

9. A device, comprising:
an imager having a field of view (FOV) extending at least partially over a region;
one or more memories; and
one or more processors, communicatively coupled to the one or more memories, configured to:
capture, via the imager, an image of an item present within the region;
classify, based on the image, the item utilizing a machine learning model;
generate, utilizing the machine learning model, one or more candidate items and a score for each candidate item based on the classified item;
determine whether a score of a candidate item among the one or more candidate items exceeds a threshold;
responsive to determining the score of a candidate item among the one or more candidate items does not exceed the threshold, retrieve, from a database, data associated with each candidate item;
modify a score of each candidate item based on the retrieved data associated with each candidate item;
select a candidate item having a highest modified score;
update the database based on the selected candidate item having the highest modified score; and
display the selected candidate item having the highest modified score.

10. The device of claim 9, wherein the one or more processors are further configured to receive a trigger associated with the item being present within the region, and receiving the trigger comprises one or more of:
detecting, by the imager, the item being present within the region;
receiving an input indicative of the item being present within the region; or
receiving a trigger from a load sensor of the device based on a measurement at the load sensor satisfying a weight threshold.

11. The device of claim 9, wherein the one or more processors are further configured to:
apply a first convolutional neural network (CNN) to the image to determine a bounding box associated with the item;
determine the item within the bounding box satisfies an occlusion threshold;
apply a second CNN to the image to determine a query image; and
classify, based on the query image, the item utilizing the machine learning model.

12. The device of claim 9, wherein
the device is a scanner; and
the threshold is one or more of:
a minimum confidence value indicative of a candidate item corresponding to the classified item; or
a minimum difference value among each score of each candidate item.

13. The device of claim 9, wherein the one or more processors are further configured to:
responsive to determining the score of a candidate item among the one or more candidate items exceeds the threshold, select the candidate item having the score that exceeds the threshold;
display the selected candidate item having the score that exceeds the threshold.

14. The device of claim 9, wherein the retrieved data associated with each candidate item is one or more of:
historical transaction data of a user associated with the candidate item;
association data indicative of one or more other items associated with the candidate item; or
time series data indicative of a seasonality associated with the candidate item.

15. The device of claim 9, wherein the one or more processors are configured to modify the score of each candidate item based on the retrieved data associated with each candidate item by increasing or decreasing the score of each candidate item based on one or more weights applied to the retrieved data.

16. The device of claim 9, wherein the one or more processors are further configured:
receive an input associated with the selected candidate item; and
cause, based on the input, a transaction to be processed using the selected candidate item.

17. A non-transitory computer-readable medium storing instructions thereon that, when executed by one or more processors, cause the one or more processors to:
capture, via an imager of a device, an image of an item present within a region, the imager having a field of view (FOV) extending at least partially over the region;
classify, based on the image, the item utilizing a machine learning model;
generate, utilizing the machine learning model, one or more candidate items and a score for each candidate item based on the classified item;
determine whether a score of a candidate item among the one or more candidate items exceeds a threshold;
responsive to determining the score of a candidate item among the one or more candidate items does not exceed the threshold, retrieve, from a database, data associated with each candidate item;
modify a score of each candidate item based on the retrieved data associated with each candidate item;
select a candidate item having a highest modified score;
update the database based on the selected candidate item having the highest modified score; and
display the selected candidate item having the highest modified score.

18. A non-transitory computer-readable medium of claim 17, wherein the instructions, when executed, further cause the one or more processors to receive a trigger associated with the item being present within the region, wherein receiving the trigger comprises one or more of:
detecting, by the imager, the item being present within the region;
receiving an input indicative of the item being present within the region; or
receiving a trigger from a load sensor of the device based on a measurement at the load sensor satisfying a weight threshold.

19. The non-transitory computer-readable medium of claim 17, wherein the instructions, when executed, further cause the one or more processors to:
apply a first convolutional neural network (CNN) to the image to determine a bounding box associated with the item;
determine the item within the bounding box satisfies an occlusion threshold;
apply a second CNN to the image to determine a query image; and
classify, based on the query image, the item utilizing the machine learning model.

20. The non-transitory computer-readable medium of claim 17, wherein
the device is a scanner; and
the threshold is one or more of:
a minimum confidence value indicative of a candidate item corresponding to the classified item; or
a minimum difference value among each score of each candidate item.

21. The non-transitory computer-readable medium of claim 17, wherein the retrieved data associated with each candidate item is one or more of:
historical transaction data of a user associated with the candidate item;
association data indicative of one or more other items associated with the candidate item; or
time series data indicative of a seasonality associated with the candidate item.

22. The non-transitory computer-readable medium of claim 17, wherein the instructions, when executed, cause the one or more processors to modify the score of each candidate item based on the retrieved data associated with each candidate item by increasing or decreasing the score of each candidate item based on a weight applied to the retrieved data.

23. The non-transitory computer-readable medium of claim 17, wherein the instructions, when executed, further cause the one or more processors to:
receive an input associated with the selected candidate item; and
cause, based on the input, a transaction to be processed using the selected candidate item.
